(19) United States
(12) Patent Application Publication
(10) Pub. No.: US 2003/0187713 A1
(43) Pub. Date: Oct. 2, 2003

(54) Response potential model

(76) Inventor: John F. Hood, Lee's Summit, MO (US)

Correspondence Address: Sean T. Bradley, Chase Law Firm, L.C., 4400 College Boulevard, Suite 130, Overland Park, KS, 66211, US

(21) Appl. No.: 10/401,078

(22) Filed: Mar. 27, 2003

Related U.S. Application Data
(60) Provisional application No. 60/368,862, filed on Mar. 29, 2002.

(51) Int. Cl. G06F 17/60

(52) U.S. Cl. 705/9

(57) ABSTRACT

A computer implemented method for generating a response potential model for optimizing direct mail marketer mailing lists.

### CROSS REFERENCE TO RELATED APPLICATION

This application claims the benefit of the prior filed, co-pending provisional application Serial No. 60/368,862, filed Mar. 29, 2002.

### COPYRIGHT NOTICE

A portion of the disclosure of this document contains material subject to copyright protection. The copyright owner reserves all rights in protected material but consents to reproduction of the patent document in the exact form it appears in the records of the U.S. Patent and Trademark Office.

### BACKGROUND OF THE INVENTION

The present invention relates to methods of generating optimized mailing lists and more particularly to methods of generating mailing lists ranked according to response potential.

Thousands of companies are involved in direct mail marketing to institutional markets like schools, school districts, early childhood centers, health care facilities, doctors' offices, and churches. Direct mail is ideally suited for certain products because mail is the most efficient medium to reach these audiences. There are over 100,000 schools and school districts, about 100,000 day care centers and head start locations, and in excess of 250,000 churches. The marketers are served by mailing list compilers which collect institutional names and address and other information about the institutions to build and maintain marketing databases. The information in these databases is then rented to direct mail marketers.

Using information available in the database, data subsets may be created based on specified institutional characteristics. Marketers use data subsets to target their mailings to markets that are more appropriate to their products or are thought to be more responsive to direct mailing. By targeting specific markets, marketers save money on printing and postage and their response rate increases. The institutions receive less unwanted or inappropriate mail.

Mailing list compilers typically assist marketers in refining their mailing lists by creating the database subsets based on marketer-specified preferences or relevant industry knowledge of the mailing list compiler. Mailing list compilers may generate market profile reports by matching the marketer's known buying customers to the compiler's database of institutions. The profile report compares the distribution of buyers to institutions through market segments. Where the proportion of buyers is higher, the market segment is producing better results for the marketer. By mailing more intensively to institutions within the better segments and less intensively to less responsive segments, marketers can save costs on direct mailings and improve sales. By linking buyer responsiveness to other selected criteria, profiling improves the targeting process.

Prior art methods of using profile data to create final mailing lists are difficult and typically involve tedious examination of multiple profile reports that may present conflicting or overlapping segment data. Profile data is particularly difficult to apply because many of the higher performing segments overlap with one another. For example, through profiling it may be determined that the following market segments are high performing: elementary schools, public schools, high enrollment schools, and high expenditure schools. It should be appreciated that each of these segments overlaps with the others. A targeted mailing list that incorporated only those institutions having all of the above characteristics would be high performing but would also tend to be over exclusive. Typically, profiles present many more than four overlapping views and the potential for overlapping views is a broad as the amount of data collected by the mailing list compiler. Hundreds of data elements are often available for each institution.

The prior art methodology for examining the mass of available profile data to generate high performing mailing lists is time consuming and success is limited to the effort, experience, and intuition of the person performing the analysis. In light of the above, there is a need for a methodology of generating more responsive mailing lists that can be used without reliance on the abilities of individual analysts.

### SUMMARY OF THE INVENTION

The present invention is a method and system for developing ranked mailing lists using a response potential model. By ranking mailing lists using the present invention, response potential is measured not only on the basis of inherent list member characteristics such as size and location, but by performance related factors such as buying history and responsiveness to direct mailings.

According to one embodiment of the present invention an optimized mailing list for a class of direct mail marketers is created by establishing a marketer class through prior knowledge of the marketers in a given industry or through similarities of individual marketers' customer lists or profile reports; identifying significant data elements for each marketer class member; conditioning the significant data elements; comparing significant data elements from all marketer class members to identify significant data elements that are common to all marketer class members and that correlate in the same direction, positively or negatively, among all marketer class members; weighting the significant data elements; developing an appropriate formula; applying the formula to each entity on a compiler database to generate a score; sorting the compiler database by the scores; dividing the sorted entities into deciles; generating reports for each marketer class member customer list; analyzing the reports for consistency of transition from one decile to the next and degree of contrast from decile containing highest scores to decile containing lowest scores to determine effectiveness of the formula; adjusting the formula based on the analysis; refining the formula by repeating the above five steps (applying, sorting, generating, analyzing, adjusting) until no further improvements are notable; and generating a production version of the optimized mailing list based on the finalized formula.

It is, therefore, the primary object of the present invention to provide a method for exploiting the information available in customer profiles to create an optimized mailing list for direct mail marketers.

Another important object is to provide a solution to the difficulties presented by overlapping profile views when generating optimized mailing lists.

Another important object is provide a response potential model for a class of direct mail marketers.

Another important object is provide a response potential model that makes mailing in proportion to market potential simpler and more accurate.

Another important object is to provide a method and formula designed to identify institutions by responsiveness to direct mail offers in combination with other selected criteria.

Another important object is to provide a method and formula developed using the response behavior patterns of multiple direct mail campaigns.

Another important object is provide a response potential model that divides a mailing list into equal segments, each segment being ranked from most responsive to least responsive.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a flow chart illustrating basic steps for practicing an embodiment of the method of the present invention.

FIG. 2 is a diagrammatic illustration of the relationship between elements used in the matching and profile creation steps of FIG. 1.

FIG. 3 is a diagrammatic illustration of exemplary profile reports for two data elements.

FIG. 4 is a diagrammatic illustration of an example of an alternative profile report format.

FIG. 5 is a table showing individually significant data elements for two profile reports for a sample customer list.

FIG. 6 is a diagrammatic illustration showing multiple customer lists having a common significant data element for identification.

FIG. 7 is table showing common significant data elements and corresponding factors.

FIG. 8 is an example of the comparative analysis of four formulas derived from the method of the present invention.

### DETAILED DESCRIPTION

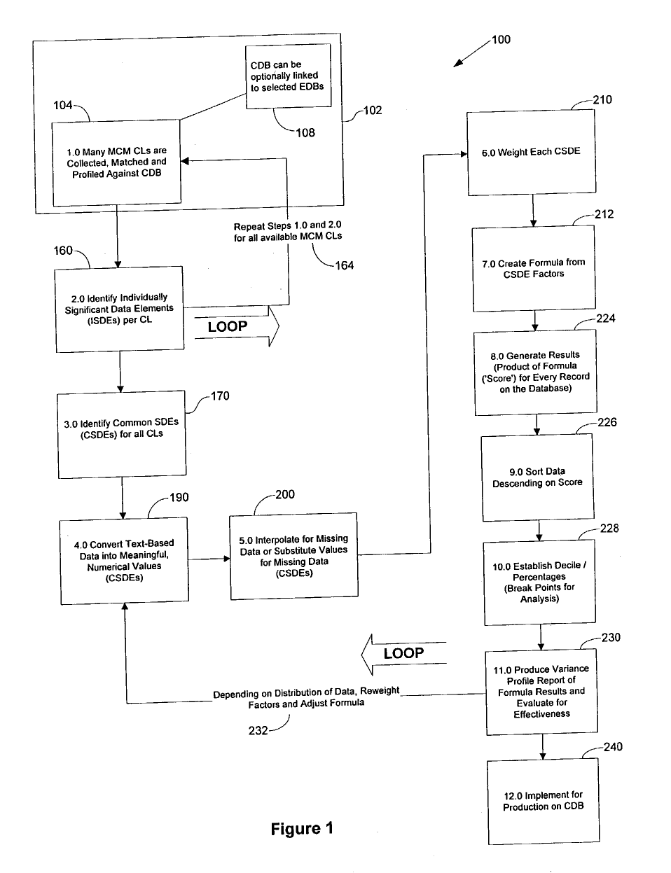

FIG. 1 illustrates an overview of the method of the present invention, generally identified by reference numeral 100. The flow diagram includes sources of data 108, matching customer lists with compiler database records 104, identification and evaluation of significant data elements 160, conditioning 170, 190, 200 and weighting 210 of common significant data elements, development of a formula 212, application of the formula to compiler database records 224, sorting records in the compiler database 226, dividing sorted entries into deciles 228, generation of reports 230, and evaluation of the formula 232 until an optimized result is achieved. Each of these steps is described in detail herein below.

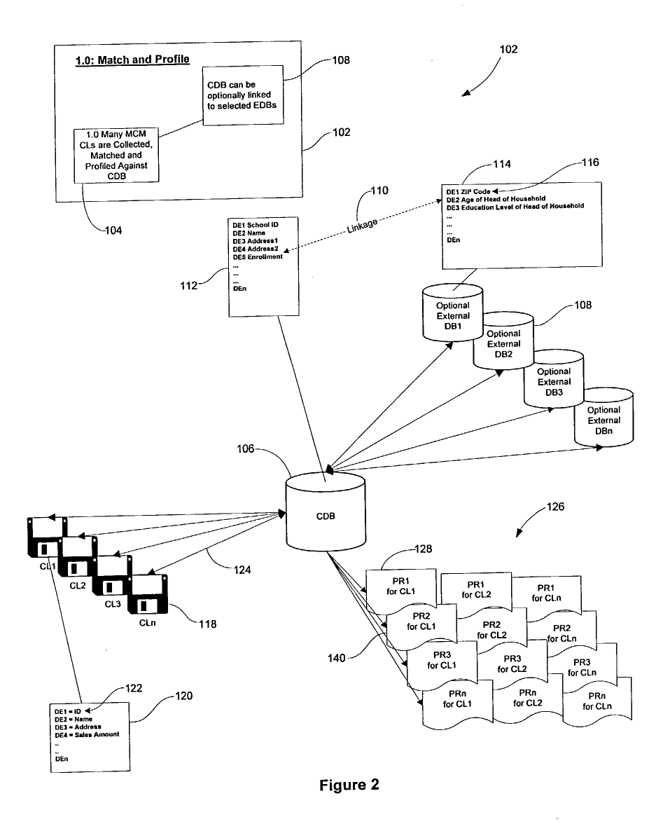

Referring to FIGS. 1 and 2, the first step is to match customer lists and generate profiles 102. Direct marketer customer lists are a good source of the most critical raw data. These lists provide identification of known buyers including significant characteristics that can be used to create profiles. These lists can come from a wide variety of sources and are typically obtained in varying formats. Each customer list is reformatted into a common format prior to the matching process. The lists are then processed through matching software and an output file of matched customer records is obtained and saved. Matched customer records typically include sales information or other information besides name and address. Sales revenue generated by a particular customer is particularly valuable information since it enables analysis not only of market penetration but also of the relative value of customers compared to other segments or groups.

These matched customer records are used to generate profiles. Matching customer lists is typically a one-time event. Once the matched customer records are created, they are stored in a database which may be accessed repeatedly as necessary. Profile creation, conversely, is typically an ongoing process with new profiles created depending on selected significant data elements.

FIG. 2 illustrates the process through which significant data elements are discovered 104. Customer files for mailer class member (“MCM”) are collected, matched and profiled against the compiler database 106 (“CDB”). Data elements are obtained from both the compiler database 106 and external databases generally indicated by reference numeral 108 (“EDB”). The external databases generally indicated by reference numeral 108 are linked 110 to the compiler database 106 through common data element fields 112 in the compiler database 106 and matching data element fields 114 in external databases 108. There are numerous external databases 108 that can be linked 110 to compiler databases 106. A link 110 to geographic data, such as zip codes generally indicated by reference numeral 116, for example, enables access to extensive Census Bureau external databases. These external databases contain thousands of data elements describing the population contained within the geographic zip code boundaries. Commercially available external databases derived from Census Bureau databases may provide even further information. In addition, the Department of Education, through the National Center for Education Statistics provides numerous external databases and thousands of additional data elements that can be linked through an ID number crosswalk. An ID number crosswalk is a table with the IDs from one database paired with the corresponding or associated ID number from another database. An ID number crosswalk table allows information one database to be posted in another database.

The class member customer lists 118 are matched to the compiler database 106 through commercial matching software that matches fields and typically updates each customer list record 120 with the compiler database 106 record identification 122 where a match is found. A data element 120 is a record or piece of information on the compiler database 106. By posting the compiler database record identification 122 on the customer list 118, a permanent link 124 is established between the associated customer lists 118 in the compiler database 106. A series of profile reports generally indicated by reference numeral 126 is then produced for each customer list 118.

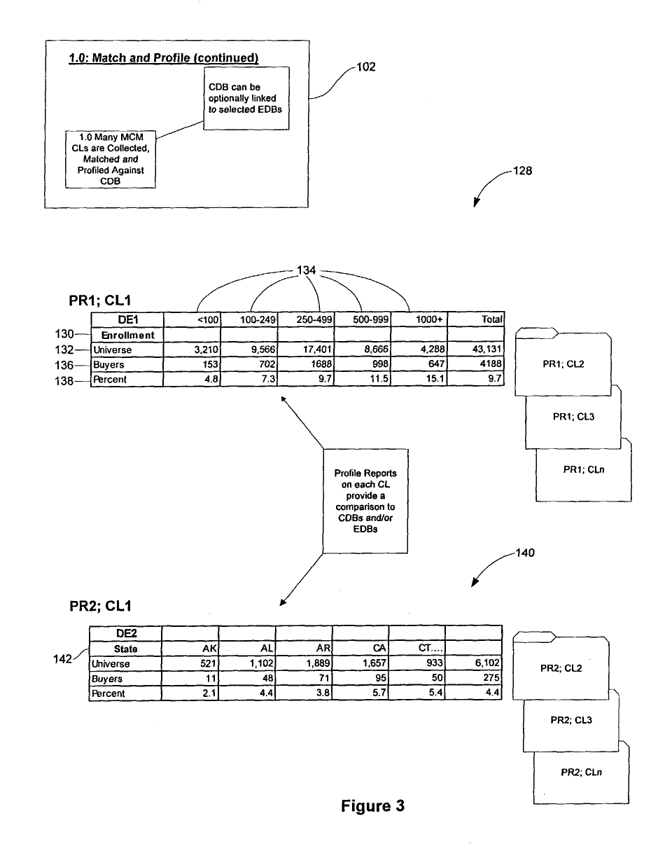

Referring to FIGS. 2 and 3, profile reports (“PR”) 126 are tabulations of the compiler database 106 or segments of the compiler database 106 showing counts of matched customer list members by various data elements. For example, profile report 1 (“PR1”) for customer list 1 (“CL1”) 128 shows counts by values of the data element (“DE1”) “Enrollment” 130. The distribution of enrollment values relates to the way data is stored in the compiler database 106. The “Universe” counts 132 typically vary widely by each enrollment category 134. The “Buyers” count 136 represents the number of unique customer list members in each enrollment category 134. “Percent” 138 is the number of customer list members as a percent of the “Universe” count 132 in each enrollment category 134. The percent 138 represents market penetration at the institutional name and address level. The market penetration is the distribution of buyers or customers list members relative to the distribution of entities indicated by institutional name and address.

Profile report 2 (“PR2”) for customer list 1 (“CL1”) 140 shows data element (“DE2”) which includes the distribution of buyers by state 142. The format of PR2 for CL1 140 is similar to PR1 for CL1 128. The format and calculated data of various profile reports may vary significantly among different profiling service providers. However, these variations do not affect the overall process 100 (FIG. 1).

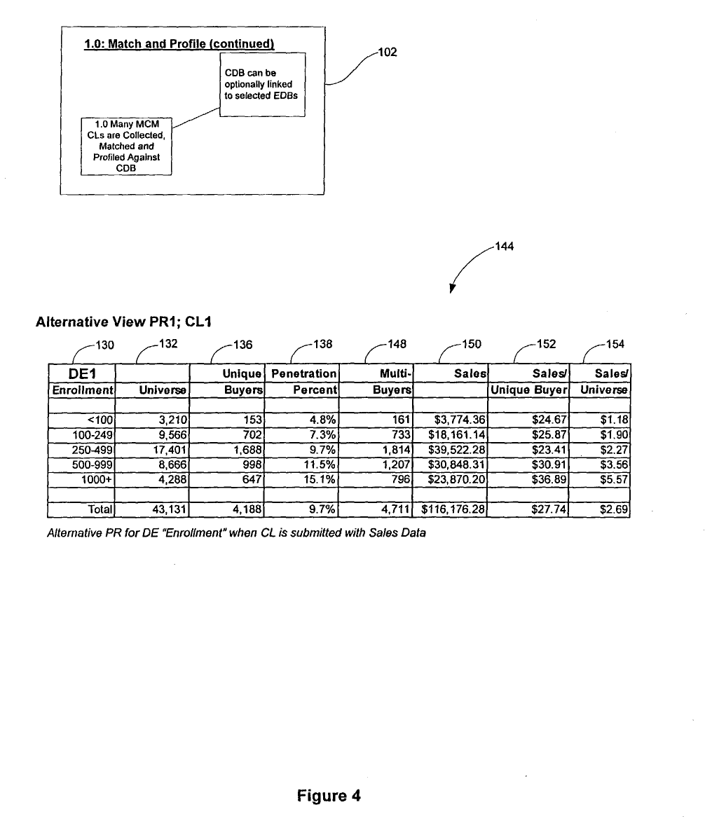

FIG. 4 further illustrates the enrollment data shown in FIG. 3. In FIG. 4, the profile report PR1 for customer list CL1 for data element DE1, generally indicated by reference number 144, contains additional sales data shown arranged in columns. The profile report 144 includes: Multi-Buyers 148 (multiple occurrence buyers), Sales 150, Sales/Unique Buyer 152, and Sales/Universe 154.

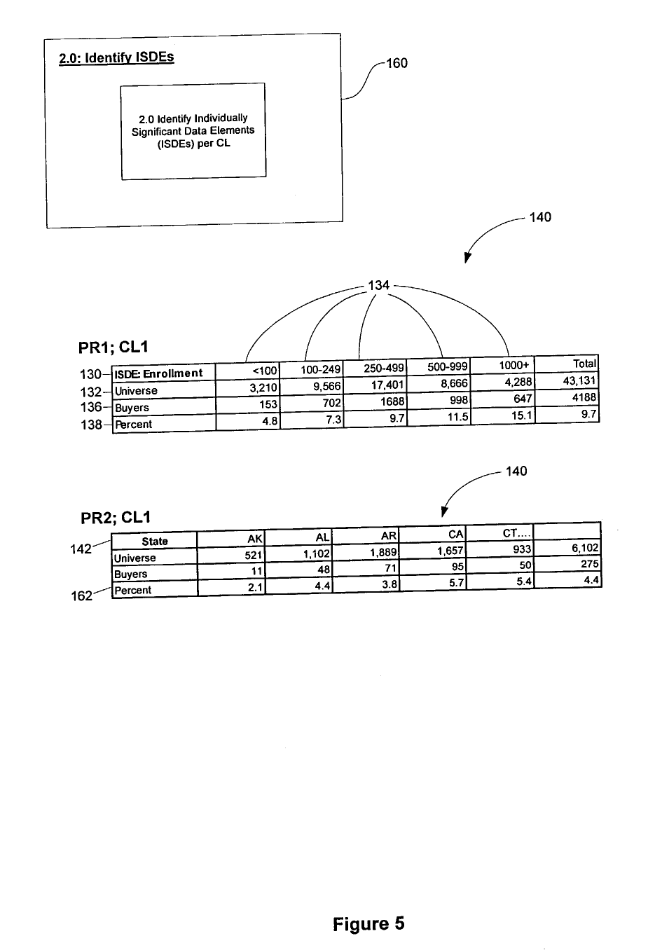

Referring to FIGS. 1 and 5, the performance of each data element is determined to identify individually significant data elements (“ISDE”) for each customer list 160. FIG. 5 depicts two data elements 130, 142 that relate to the performance of a sample customer list. This information is indicative of a form of data element presentation from the customer list matching and profiling step and also of the analytical process by which the data is evaluated.

The data elements are evaluated on the basis of contrast, coverage, and consistency. Contrast is the variation in distribution of the customer list members (buyers) between the high and low values by which the data element is presented. If there is no substantial difference between the market penetration at the low end of the range and at the high end of the range, then the data element is not significant to the customer list. If there is a substantial difference then the data element is potentially significant. Substantiality of differences may be evaluated statistically or by other criteria developed by the user.

Coverage refers to the number of data elements or universe 132 at each value level 134. If the number is too small in relation to the universe total, the contrast noted may not be meaningful. Meaningful contrasts are those where there is substantial coverage at both high and low values.

Consistency relates to transition across value ranges. The transition must be progressive to have predictive value. For example, the progression of market penetration percents 138 for Enrollment data element 130 for customer list 1 (“CL1”) 128, as shown in FIG. 5, is 4.8, 7.3, 9.7, 11.5, and 15.1. Since the market penetration percent 138 increases with the enrollment size 134 of the school, there is a consistent or smooth transition across categories. If, for example, the progression of market penetration percents 138 was 4.8, 11.5, 9.7, 7.3 and 15.1, it would not be considered a significant data element because of inconsistency. Additionally, percent 138 shows a marked contrast between lowest and highest values (4.8 versus 15.1). The values at both extremes also have significant coverage, 7.4% for the low enrollment category value and 9.9% (4,288 divided by 43,121) for the high enrollment category value (3210 divided by the universe total 43,131). This type of distribution of values would typically qualify the enrollment data element 130 as an individually significant data element for this customer list 160. Although the percentages 162 appear to be inconsistent for State data element 142 of customer list 1 (PR2 of CL1) 140, there is not the same relationship between the State categories to the percentage 162 as there is between enrollment 130 and percent 138. Thus, State data element 142 may nonetheless be considered an individually significant data element (ISDE) 160.

The process of identifying individually significant data elements is repeated 164 for all available mailer classes members customer lists (FIG. 1).

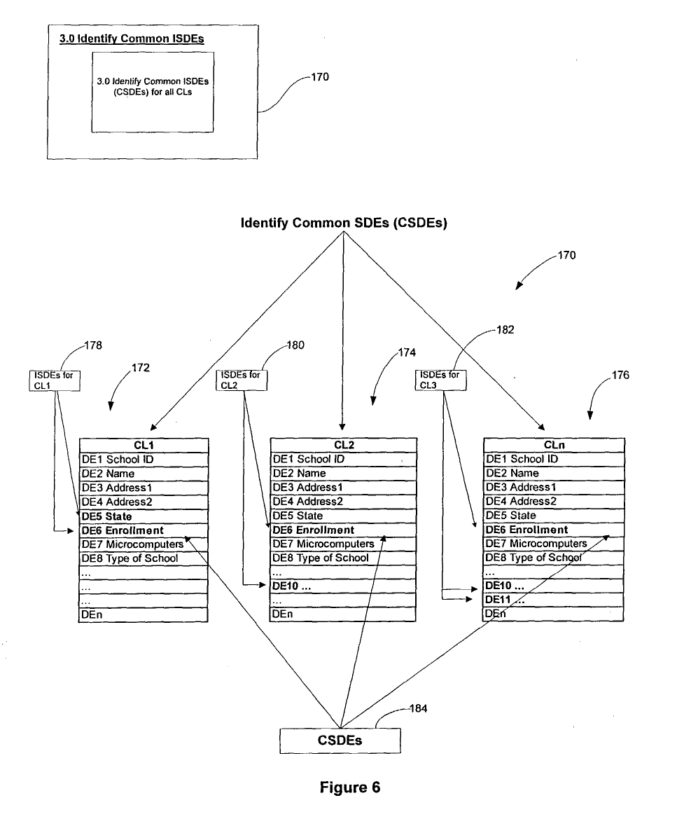

Referring to FIGS. 1 and 6, the process of identifying common significant data elements (“CSDE”) 170, generally indicated by reference numeral 172 for CL1; 174 for CL2; and 176 for CL3, from the candidate individually significant data elements, is illustrated. A profile report for one customer list may show hundreds of data elements. In the process of identifying common significant data elements (178 for ISDEs for CL1; 180 for ISDEs for CL2; and 182 for ISDEs for CL3) and developing formulas, however, it is common to broaden the search to data elements found on external databases or data elements typically overlooked on the compiler databases. In either case, identifying individually significant data elements optimally begins with a review of every data element presented in the profile report.

To identify the individually significant data elements that are common to most or all of the CLs (172, 174 and 176) within the mailer class (MC), each of the identified ISDEs must also have the same type of correlation for the data element with the customer list 184. In other words, the correlation for a data element is either positive on all customer lists or negative on all customer lists. Correlations which are opposite indicate that the data element is not common across CLs. As shown in FIG. 6, enrollment is a common significant data element 184.

Many of the common significant data elements (“CSDE”) are alphanumeric rather than strictly numeric. For example, the “Type of School” data element may have values such as Public, Catholic, Private-non-religious, and Private-non-Catholic religious. This common significant data element may be converted 190 to a numeric value or another associated field data element may be established, such as “Control Factor” for example, that would carry a numeric value based on the information in the “Type of School”. The values in the new data element would not only be numeric, but would also carry a data element preliminary weighting to reflect their impact on the customer lists. For example, the Control Factor for Public “Type of School” data element may be set to 2.0; for Catholic, 1.8; for Private-non-religious, 2.5; and Private-non-Catholic religious, 1.5. Each text or non-numerically formatted common significant data element should be converted 190 to a numeric value so that it may be directly input into a formula.

It may be common for entities on a compiler database to have missing values in some data elements. Sometimes the value is inappropriate for the entity, and other times the data may be appropriate but not available, for example. Knowledge of the compiler database and of the nature of the common significant data elements is important in dealing with missing data in order to avoid distortion of the formula output. If there are few entities where the data is not available and the common significant data element is fundamental to the formula, the entity should be bypassed resulting in the entity not being scored. Missing entities may also be assigned a nominal value that represents a neutral position 200. By assigning a nominal value the entity may be used in the response potential model formula (discussed in detail hereinbelow), resulting in a somewhat less accurate score and positioning for the entity. However, the other common significant data elements will position the entity reasonably well for a well designed formula. Another way to deal with missing data is to infer or interpolate values from other sources.

Inferring values may be done when there are many missing values and assigning the same neutral value to each would result in a flat distribution of the scores. The inferred values are determined by adjusting the neutral value based on other inputs from the profile data. For example, the relative performance by state could be used to adjust an assigned value up or down.

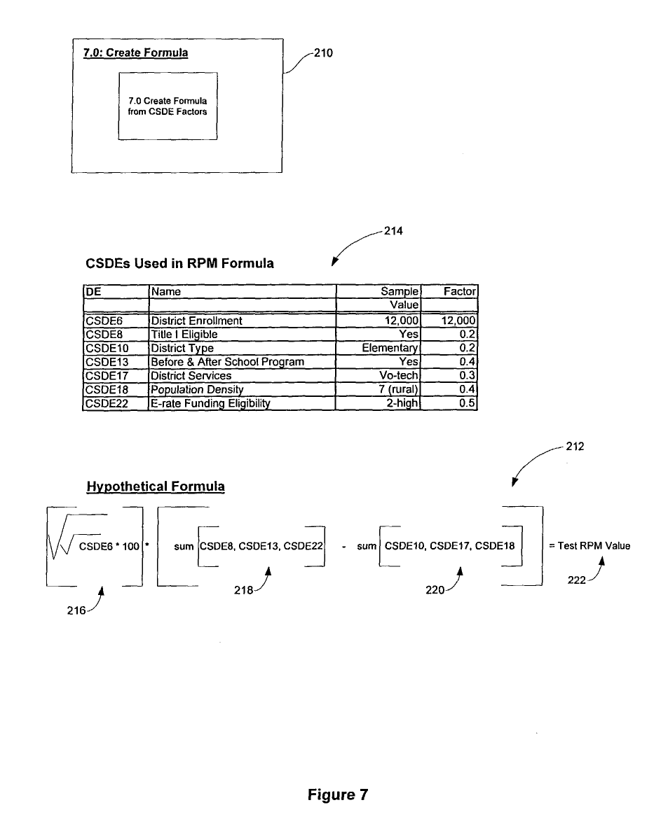

Referring to FIGS. 1 and 7, all the common significant data elements have a relationship with the customer lists by definition. The objective of the weighting of the CSDEs 210 is to have them each make a proper contribution to the formula 212 and resulting scores. Consequently various mathematical functions and other means are used to balance the inputs 214 to the formula 212. For example, if the range of values in a particular CSDE was too broad, say 100:1, the square root of the CSDE might be employed as a weighting device 216. That would have the effect of reducing the range to 10:1. Changing the weightings is also one of the methods used to vary the outcome of the formula to “tune” the results.

The RPM formula 212 is simply a way of combining the weighted or adjusted CSDEs 214 such that the result of the formula is a score (number) that, when assigned to each applicable entity on the CDB, provides enough variance to be able to sort the file in score order. The formula 212 must use the CSDE inputs so that the results correlate with the CL relationships. In other words, the formula is constructed so that, for example, positive inputs 218 are added and negative inputs 220 subtracted such that the resulting score or RPM score 222 will accurately reflect the combined effect of the inputs. That should make the score 222 have a more dramatic correlation with each of the CLs than any of the individual CSDEs, each of which has an already established correlation. A score is generated for each applicable entity on the database 224.

Based on their score, each appropriate entity is sorted and ranked in descending order 226. A rank data element and input a sequential number is added to each record starting with 1. The first record is the top (or best) entity on the CDB according to this formula and weighting and the end record is the last (or worst).

The entities are grouped by decile or percentile using the rank 228 and the corresponding decile/percentile number is added to each record “Decile” and “Percentile”. The calculation is as follows:

Total entities/10=decile.

Entities with ranks <=total entities/10*1=decile 9;

Entities with ranks >tot entities/10*1 and <=tot entities /10*2=decile 8; etc.

Repeat through decile 0.

Total entities/100=percentile.

Entities with ranks <=tot entities /100*1=percentile 99;

Entities with ranks >tot entities /100*1 and <=tot entities /100*2=percentile 98; etc.

Repeat through percentile 0.

Also, first digit of percentile=decile.

Once the first formula results have been updated on the compiler database, a variances profile is run on the customer lists to evaluate the effectiveness of the formula 230. The format and data is similar to a profile, but the only DE described is the new score. The first score is the benchmark which is to be improved upon. Subsequent evaluations are made 232 by comparing them to the first formula similarly to the way individually significant data elements are evaluated—by their contrast and consistency. Coverage is not an issue as the compilers database is divided into deciles making the extremes always equal to tenths of the CDB. However, in comparing these profile reports, the question is which candidate scoring formula generates the greatest contrast and the most consistency.

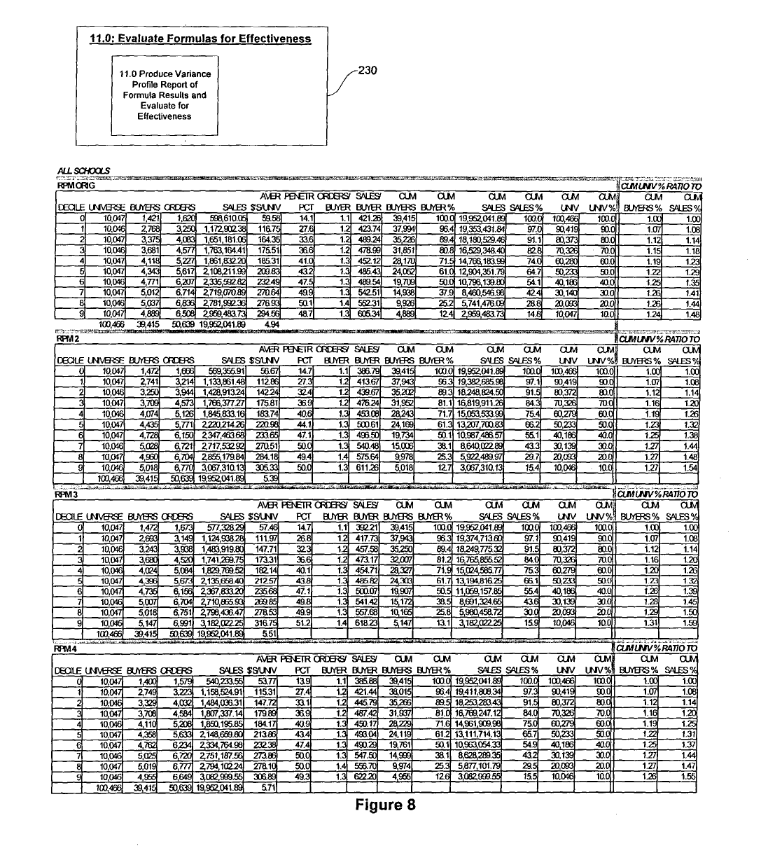

FIG. 8 represents the final comparison of candidate formulas (called RPM ORIG, RPM2, RPM3, and RPM4). For the final review, all the customer lists are combined into one and compared in the aggregate. In this example, these customer lists also include sales dollars. Therefore, the evaluation is made on the basis of contrast and consistency in both market penetration and aggregated sales. Based on this comparison of each of the candidate formulates, RPM3 is chosen because RPM3 shows a greater variance for these values over the other formulas 240.

By way of example and illustration, and referring to FIG. 1, a Church RPM is described as follows. The Church RPM is a formula to rank churches in order of their likelihood to respond to direct mail offers from church products marketers. It uses a variety of factors (selections) that have shown in profiles to relate to market penetration. When used, no other selections are necessary.

The biggest obstacle in developing the Church RPM is that 40% of the database does not have a value for congregation size. Congregation size and wealth are the dominant factors in the formula 160, 170. Consequently, the main effort is to infer a reasonable congregation size where values are missing 200. The starting point for substituting missing values 200 is using a size that is determined by the average market penetration of unsized records compared to records with sizes which may be a starting value of 241, for example.

A denominational penetration factor is determined by taking the Penetration %(PP) from the table below as follows:

DPF=(PP−20)/100+1.

In the table blow, the denomination code corresponds to a specific denomination, such as Catholic, and the corresponding calculated penetration percentage. In this example, the average PP is 20.

Next, the Denomination Adjusted Congregation Size (DACS) is calculated as follows, where 241 is the average congregation size:

DACS=241*DPF

| Denom. | |
|---|---|
| Code | Penetration % |
| 5510 | 31.5262988061 |
| 6000 | 31.5171661559 |
| 5153 | 30.8176100629 |
| 5878 | 27.9710144928 |
| 5115 | 26.5027322404 |
| 5943 | 26.3446761800 |
| 5125 | 26.2068965517 |
| 5165 | 25.9984338293 |
| 5505 | 25.2356311218 |
| 5715 | 25.1231527094 |
| 5809 | 24.5762711864 |
| 5135 | 24.1935483871 |
| 5823 | 23.0292792793 |
| 5830 | 22.6072607261 |
| 5730 | 22.4780505286 |
| 5145 | 22.2222222222 |
| 5205 | 22.1360109539 |
| 5310 | 22.0939038243 |
| 5821 | 21.3559322034 |
| 5860 | 20.6666666667 |
| 5833 | 20.3562340967 |
| 5890 | 20.0918484501 |
| 5848 | 19.9598796389 |
| 5863 | 19.7740112994 |
| 5839 | 19.0909090909 |
| 5160 | 19.0584714549 |
| 5806 | 18.9153085760 |
| 5910 | 18.0555555556 |
| 5105 | 18.0458828349 |
| 5050 | 17.7666666667 |
| 5819 | 17.5000000000 |
| 5820 | 17.4358974359 |
| 5884 | 17.3919949174 |
| 5625 | 17.3780487805 |
| 5220 | 17.0868347339 |
| 5851 | 16.6666666667 |
| 5815 | 16.2853297443 |
| 5550 | 15.7894736842 |
| 5400 | 15.7715376227 |
| 5827 | 15.7657657658 |
| 5824 | 15.6908665105 |
| 5556 | 15.6521739130 |
| 5836 | 15.3846153846 |
| 5150 | 15.3647514526 |
| 5812 | 15.3273017563 |
| 5630 | 14.9780380673 |
| 5803 | 14.5695364238 |
| 5818 | 13.9596136962 |
| 5940 | 13.8825324180 |
| 5210 | 13.5787463101 |
| 5725 | 13.4287661895 |
| 5130 | 13.3310128785 |
| 5515 | 13.1850675139 |
| 5845 | 12.6865671642 |
| 5620 | 12.5000000000 |
| 5800 | 12.4610591900 |
| 5925 | 11.6981132075 |
| 5120 | 11.6279069767 |
| 5225 | 11.1111111111 |
| 5110 | 10.8655616943 |
| 5710 | 10.0852272727 |
| 5866 | 9.9099099099 |
| 5705 | 9.8712446352 |
| 5235 | 9.4117647059 |
| 5967 | 8.4243369735 |
| 5555 | 8.0645161290 |
| 5554 | 7.9646017699 |
| 5558 | 7.6923076923 |
| 5151 | 7.3825503356 |
| 5842 | 7.2425828970 |
| 5854 | 7.0357554787 |
| 5881 | 6.9215109704 |
| 5230 | 6.6115702479 |
| 5887 | 6.4202334630 |
| 5934 | 6.1466570812 |
| 5958 | 6.0606060606 |
| 5140 | 5.4794520548 |
| 5869 | 5.2132701422 |
| 5215 | 5.1502145923 |
| 5857 | 5.0847457627 |
| 5720 | 5.0000000000 |
| 5305 | 4.8582664263 |
| 5605 | 4.7741935484 |
| 5615 | 4.0111940299 |
| 5552 | 4.0000000000 |
| 5964 | 3.6363636364 |
| 5610 | 3.5714285714 |
| 5735 | 3.0769230769 |
| 5937 | 3.0769230769 |
| 5170 | 2.9702970297 |
| 5961 | 2.7522935780 |
| 5913 | 2.4509803922 |
| 5949 | 1.7751479290 |
| 5952 | 1.6393442623 |
| 5155 | 1.5885623511 |
| 5946 | 1.5495867769 |
| 5955 | 1.3513513514 |
| 5919 | 0.6188118812 |
| 5922 | 0.3436426117 |
| 5931 | 0.3353658537 |

The corresponding DACS is inserted in a new field (New Congregation Size) on the compiler database based on denomination wherever congregation size is missing, and the existing congregation size where available.

The New Congregation Size is then adjusted for wealth, where wealth code is available 210.

Calculate Wealth Code Adjustment Factor (“WCAF”) as follows:

WCAF=(1−([Wealth Score]/10))+0.5

In this example, the wealth score ranges from 1 to 10, 1 corresponding to wealthy and 10 corresponding to poor.

Next, the Wealth Adjusted Congregation Size (“WAGS”) is calculated as follows to re-weight the congregation size by the wealth code adjustment factor:

WAGS=[New Congregation Size]*WCAF

The WAGS is posted in a new field.

Next, an adjustment for State Penetration is made. State Code Adjustment Factor (“SCAF”) is calculated based on the Penetration PCT from the table below, referred to as the State Code Penetration Percent (“SCPP”) in the following calculation, where 80 is an averaging factor to cluster around 100%, in order to reweight the score according to Penetration Percent for State:

SCAF=(SCPP+80)/100

| STATE | PENETRA- |
|---|---|
| CODE | TION PCT |
| MI | 23.9207 |
| CT | 23.1621 |
| FL | 22.6648 |
| MD | 22.6187 |
| OH | 22.2346 |
| MN | 20.9941 |
| NJ | 20.8039 |
| WI | 20.6443 |
| AZ | 20.5916 |
| CO | 20.3271 |
| NV | 19.7836 |
| IL | 19.7525 |
| IN | 19.7504 |
| CA | 19.0186 |
| DE | 18.6964 |
| PA | 18.0574 |
| VA | 18.0550 |
| RI | 17.8010 |
| TX | 17.7886 |
| NY | 17.0407 |
| WA | 17.0202 |
| ID | 16.7954 |
| KS | 16.7939 |
| HI | 16.7656 |
| SC | 16.7463 |
| MO | 16.7227 |
| DC | 16.7095 |
| MA | 16.7050 |
| LA | 16.6950 |
| NC | 16.3670 |
| OR | 15.9765 |
| GA | 15.7964 |
| NM | 15.6196 |
| IA | 14.7464 |
| NE | 14.2744 |
| WY | 14.1321 |
| KY | 14.0682 |
| AK | 13.9810 |
| OK | 13.6435 |
| TN | 13.5638 |
| MT | 13.0265 |
| AL | 13.0207 |
| UT | 12.5725 |
| ME | 12.5470 |
| NH | 12.3429 |
| WV | 12.0093 |
| AR | 11.5346 |
| ND | 11.1111 |
| SD | 11.1111 |
| MS | 10.1893 |
| VT | 8.0221 |

The State Adjusted Congregation Size (“SACS”) is calculated and posted in new field 212.

[SACS]=[WAGS]*SCAF

The final Adjusted Congregation Size (“FACS”) is determined by adjusting the SACS as follows. If the church has an associated school, multiply [SACS] by 1.3 to get FACS; otherwise multiply by 1.0. Then, post the FACS in a new field as the RPM score 224. The file is then sorted descending based on RPM score 226 and a sequential rank number is assigned to each record 228.

Next, the rank number is used to divide the file into deciles or percentiles and the appropriate decile/percentile number is added to a decile or percentile field. Variances are then produced 230 and evaluated, and the process repeated 232 until the final formula is chosen 240.

Having thus described the invention, what is claimed as new and desired to be secured by Letters Patent is as follows:

1. A computer implemented method for generating a response potential model, said method comprising the steps of:
establishing a marketer class having individual class members,
identifying significant data elements for each of the class members,
identifying significant data elements that are common among the class members,
conditioning the common significant data elements,
weighting the common significant data elements to reflect the predicted relative impact of each common significant data element on the class member response potential,
developing a formula using the weighted common significant data elements to generate a score for each class member,
ranking the class members based on each class member's score,
evaluating the effectiveness of the formula to predict response potential by calculating one or more response potentials using data elements from one or more selected class members with known responses, and
revising the formula based on the evaluation of effectiveness.

2. A system for predicting customer response, said system comprising:
a customer database for storing selected customer data elements in association with one another including customer identification data and customer profile data,
means for identifying common significant data elements among customer profile data,
means for assigning a score to customers based on said common significant data elements, said means for assigning including means for conditioning said common significant data elements, means for weighting said conditioned data elements, and means for calculating said score using said weighted data elements,
means for ranking said customers based on said score, and
means for evaluating the predictive value of said score.

3. A computer implemented method for creating an optimized mailing list for a class of direct mail marketers, said method comprising the steps of:
establishing a marketer class,
identifying significant data elements for marketer class members,
comparing significant data elements to identify significant data elements common among marketer class members,
conditioning the common significant data elements,
weighting the conditioned data elements, and
developing a formula to combine the impacts of weighted elements, thereby creating, as a product of the formula, a response potential data element having more predictive value than the individual significant data elements.

4. The method of claim 3 wherein the step of establishing a marketer class includes grouping market class members through prior knowledge of the marketers in a given industry.

5. The method of claim 3 wherein the step of establishing a marketer class includes grouping market class members through similarities of individual marketers' customer lists or profile reports.

6. The method of claim 3 wherein the step of comparing significant data elements includes selecting significant data elements that correlate in the same direction, positively or negatively, among a majority of marketer class members.

7. The method of claim 3 wherein the step of conditioning the common significant data elements includes converting text data to numerical values.

8. The method of claim 3 wherein the step of conditioning the common significant data elements includes assigning nominal values to missing data elements.

9. The method of claim 3 wherein the step of conditioning the common significant data elements includes assigning inferred values to missing data elements.

10. The method of claim 3 wherein the step of developing a formula further comprises the steps of:
applying a preliminary formula to each entity on a compiler database to generate a score,
sorting the compiler database by the scores,
dividing the sorted entities into deciles,
generating reports for each marketer class member customer list,
analyzing the reports for consistency of transition from one decile to the next and degree of contrast from decile containing highest scores to decile containing lowest scores to determine effectiveness of the formula,
adjusting the formula based on the analysis,
refining the formula by repeating the steps of applying, sorting, generating, analyzing, and adjusting until no further improvements are noted within selected parameters.

11. The method of claim 10 further comprising the step of generating a production version of the optimized mailing list based on the finalized formula.

12. A computer program product for modeling customer response potential comprising:
a computer readable storage medium having computer readable program code embodied in said medium, said computer readable program code comprising:
computer readable code which stores data elements associated with marketer class members;
computer readable code which identifies significant class member data elements;
computer readable code which identifies significant class member data elements common to selected class members;
computer readable code which conditions said common significant class member data elements;
computer readable code which assigns a weighted value to said common significant class member data elements;
computer readable code which generates a score associated with said weighted value based upon user-selected criteria;
computer readable code which ranks the class members according to said score; and
computer readable code which generates an optimized mailing list based on said rank.
